(19) United States
(12) Patent Application Publication
(10) Pub. No.: US 2026/0316102 A1
(43) Pub. Date: Oct. 15, 2026

(54) DEVICE FOR TREATING SUBSTANTIALLY VERTICAL SURFACES

(71) Applicant: Wilhelmsen Ships Service A/S, Kastrup (DK)

(72) Inventors: Søren Freiesleben, Valby (DK); Søren Skovlund, Værløse (DK); Niels Torp Madsen, København Nv (DK)

(73) Assignee: Wilhelmsen Ships Service A/S, Kastrup (DK)

(21) Appl. No.: 19/108,600

(22) PCT Filed: Sep. 4, 2023
(86) PCT No.: PCT/DK2023/050212

§ 371 Date: Mar. 4, 2025

(30) Foreign Application Priority Data
Sep. 5, 2022 (DK) PA 2022 70432

(51) Int. Cl. B05B 9/03; B05B 12/16

(52) U.S. Cl. CPC B05B 9/03; B05B 12/16

(57) ABSTRACT

A device for treating substantially vertical surfaces and/or overhanging surfaces, said device includes a base unit, a pole and a tool-carrier head section. The base unit includes a structure allowing attachment to the pole, grip(s) for an operator, control elements for the device, and a winch attached to the base unit. The base unit is allowed to move on a substantially horizontal surface. The pole is attached in one end to the base section and in the other end to the tool carrier head section. The tool carrier head section allows the tool carrier head section to move up or down on the vertical or overhanging surfaces, and allows accommodating one or more tools. The base unit is connected to the pole by a pivotal hinge allowing movement of the pole around the pivotal hinge so the pole can have an adjustable angle with respect to horizontal. The pole in the other end is connected to and supports the tool carrier head section.

### FIELD OF THE INVENTION

The invention relates to a device for treating substantially vertical surfaces, in particular surfaces forming the inside of a cargo room in a cargo ship, especially dry-bulk cargo and liquid cargo ships. The treatment may be a cleaning process.

### Background for the Invention

In modern shipping it is customary to accept different cargos for a cargo ship, so that in a typical cargo shipping organization the nearest ship is allocated to a new cargo that need transport. This naturally creates situations where the cargo of a cargo ship may change from one delivery to the next delivery performed by the ship.

In order to operate a cargo ship in this way it may be necessary to clean the cargo rooms between cargos in order to avoid that a cargo is contaminated by remains of the previous cargo.

The cleaning process typically involves spraying the contaminated surfaces with a cleaning solution, usually water, optionally supplemented with cleaning chemicals depending on the nature of the contamination and may further involve additional operations such as brushing.

Since cargo rooms in cargo ships may be large, such as with a height of up to 20 m or even higher, it may be difficult for the crew of the ship to perform an efficient cleaning operation from the base of the cargo room, and there is therefore a need to provide suitable tools that allows the crew to perform an efficient cleaning of the walls of such cargo rooms.

### SHORT DESCRIPTION OF THE INVENTION

The invention relates to a device for treating substantial vertical surfaces and/or overhanging surfaces comprising a base unit, a pole and a tool-carrier head section; wherein
a. the base unit providing a structure for attachment to the pole, provided with means to roll on a substantially horizontal surface, grip(s) for the operator and control elements for the device;
b. the pole being attached in one end to the base section and in the other (distant) end to the tool carrier head section; and
c. the tool carrier head section comprising means to roll up or down the vertical or overhanging surfaces, and capable of accommodating one or more tools;
   wherein the base unit is connected to the pole by a pivotal hinge allowing movement of the pole around the pivotal hinge so the pole can have an angle with the horizon in the range of 0-90°, and wherein the pole in the other end is connected to the tool carrier head section with a connection allowing the tools of the tool-carrier head section to engage with the surface on which it is located.

Preferably, the base section is provided with a winch and a line attached to the winch, which line during operation can be led via an overhead support to the distal end of the pole or to the tool carrier head section. In this way a substantial part of the weight of the pole, the tool carrier head section and optional feed tubes, can be carried by the line and thereby reducing the force required by the operator during use of the device.

The invention further relates to the use of the device of the invention for treating substantially vertical surfaces.

The treatment operation may be a cleaning, painting, impregnating, anti-corrosive treatment, abrasive treatment etc. ; but preferably a cleaning process.

### Short Description of the Figures

FIG. 1 shows a tool-carrier head section of the invention. For further details see example 1. The figure shows high pressure nozzles (1) mounted on a tool-carrier head section further comprising wheels (2a and 2b) and being connected to the pole (3), via the hinge (12).

FIG. 2 shows a tool-carrier head section of the invention. For further details see example 2. The figure shows high pressure nozzles (1) mounted on a tool-carrier head section further comprising wheels (2a and 2b) and being connected to the pole (3), via the hinge (12).

FIG. 3 shows the ends of pole elements-For further details se example 3. The figure shows the ends of the pole sections (3) with holes (4a and 4b) for locking the elements in assembled form.

FIG. 4 shows the cross section of a typical cargo room of a bulk-carrier vessel.

FIG. 5A-5C show details of a base unit of the invention. For more details see example 4. The base unit comprises a section for attachment of the pole (3), handles for the operator (5) and a winch (6).

FIG. 6A-6D show details of a device of the invention. For more details see example 4. FIG. 6B shows a section for attachment of the pole (3), handles for the operator and a winch (6); FIG. 6C shows the pole (3) and the line (7) connected to the winch in one end and the pole (3) in the other end. FIG. 6D further shows the feeding tube (8) providing high pressure water for the nozzles, the feeding tube hanging down from above.

FIG. 7A-7B show details of a base unit of the invention. For further details see example 5. On the base unit is seen a part of a pole section (3) for attachment of further pole elements, handles (9) for the operator, a winch (10) and an arrangement (11) for storing pole element when not in use.

FIG. 8A-8D show pictures of the device disclosed in example 5 for treating a surface in a cargo room of a vessel. On FIGS. 8C and 8D the overhead support (7) can be seen in form of a wire spanning the open top hatch of the cargo room supporting the line at point (11).

FIG. 9 shows a schematic view of a device of the invention placed at a wall at a cargo room of a vessel. Force-vectors showing how the weight is carrier by the line is indicated on the figure. For further explanation see example 8.

### DETAILED DESCRIPTION OF THE INVENTION

The invention provides a device for treating substantial vertical surfaces and/or overhanging surfaces comprising a base unit, a pole and a tool-carrier head section; wherein
a. the base unit providing a structure for attachment to the pole, provided with means to roll on a substantially horizontal surface, grip(s) for the operator and control elements for the device;
b. the pole being attached in one end to the base section and in the other end to the tool carrier head section; and
c. the tool carrier head section comprising means to roll up or down the vertical or overhanging surfaces, and capable of accommodating one or more tools;
   wherein the base unit is connected to the pole by a pivotal hinge allowing movement of the pole around the pivotal hinge so the pole can have an angle with the horizon in the range of 0-90°, and wherein the pole in the other end is connected to the tool carrier head section with a connection allowing the tools of the tool-carrier head section to engage with the surface on which it is located.

Preferably, the base section is provided with a winch and a line attached to the winch, which line during operation can be led via an overhead support to the distal end of the pole or to the tool carrier head section. In this way a substantial part of the weight of the pole, the tool carrier head section and optional feed tubes, can be carried by the line and thereby reducing the force required by the operator during use of the device.

### Base Unit

The base unit of the device is the controlling part of the device and is the part operated by the operator during operation. It has a basis capable of standing on a substantially horizontal surface in operational distance to the surface to be treated, comprises handles for the operator's engagement with the unit, rolls or wheels for moving the unit on the substantially horizontal surface and it may comprise controls, e.g. in form of a control panel, for engines, brakes, winch, tools etc., if provided at the device.

The substantially horizontal surface is the surface of a free space next to the surface to be treated, where the device is placed during operation. Examples include but is not limited to: the floor/bottom of a tank, when the surface to be treated is the sides of a tank, e.g. a cargo tank in a bulk carrier ship; or it may be a grass covered land next to a wall if the surface to be treated is wall on a land based building/plant. The substantially horizontal surface should be sufficiently firm and solid to allow the base unit to roll on the surface.

The rolls or wheels may be any rolls or wheels known in the art, allowing easy movement of the unit towards or away from the surface to be treated, or relocation of the device from one section of the surface that has been treated to the next section that should be treated.

It is preferred that the base unit comprises 3 or more wheels in order to give the unit a stable footage during operation.

The skilled person will appreciate that the wheels should be selected depending on the characteristics of the substantially horizontal surface where the device is intended to be used, for example if the substantially horizontal surface is a metal floor/bottom of a tank in a bulk carrier, small wheels having a good grip on such a surface can be selected, whereas if the substantially horizontal surface is grass land, wider and larger wheels are preferred in order to move easily on such a surface. It is within the capabilities of the average practitioner to select suitable wheels for the intended use.

The base unit may be provided with an engine connected to one or more wheel(s) in order to facilitate movement of the device.

Further, one or more wheels may be provided with a break to avoid unintended movement of the unit. The break may be of a type that prevent the wheel from rolling at all, or it may be of a type that allows the wheel to roll in one direction and prevents rolling in other directions. The latter may be of benefit if the device is used on a ship that moves due to waves in the ocean, because this allows the device to roll towards and away from the surface to be treated as required during operation, but prevent any rolling in other directions.

The base unit may further comprise a winch provided with a line connected to the tool carrier head section via an overhead support, and/or a section for storing pole sections and/or tool-carrier head sections, when not in use.

The base unit is connected to the pole by a pivotal hinge allowing movement of the pole around the pivotal hinge so the pole can have an angle with the horizon in the range of 0-90°, preferably 0-80°, where 0° is intended to mean horizontal and 90°is intended to mean vertical.

### Pole

The pole is the part connecting the base unit with the tool-carrier head section and providing the device with the desired operation range for the intended use.

The pole may have a length in the range of 1-40 m, e.g. in the range of 1.5-30 m, e.g. in the range of 2-20 m.

The pole may be made as a single section having the desired length or it may be composed of 2 or more sections that can be assembled before use in the intended length.

It is preferred to use a pole composed of 2 or more section in order to provide more flexibility and further to ease storage and transport of the device. It is further preferred that the 2 or more sections forming the pole are provided with means to lock the sections in assembled form to avoid unintended disassembly of the pole during operation. Such locking means are known in the art and the present invention is not limited to any particular locking means.

The cross section of the pole may be any convenient geometrical form, such as circular, elliptic, square, triangular, polygonal, I-profile form, and the invention is not limited to any particular form.

The pole is preferably made of a material and shape providing a satisfactory stiffness of the pole. However, it is also preferred to use a material that is not too heavy in order to facilitate operation of the device. Examples of suitable materials for the pole include but is not limited to: aluminum, light metals and alloys, acrylics, polycarbonate, polyester and wood. The skilled person knows how to select suitable materials based on these requirements.

### Tool-Carrier Head Section

The tool-carrier head section is attached to the pole in the end proximal to the base unit, with a hinge that allows the tools connected to the tool-carrier head section to have essentially same angle to the surface to be treated when the tool-carrier head section is moved up or down the surface.

For some uses, e.g. for cleaning a corrugated bulk head section of a bulk carrier vessel, it is preferred to connect the pole to the tool-carrier head section with a hinge that allows movement in all directions, such as a ball-and socket hinge.

Alternatively, the tool-carrier head section may be provided with tools that can engage sidewise with a surface that is substantially perpendicular to the surface on which the tool-carrier head section is rolling, and in this way treat a corrugates bulk head section wall.

Further, the tool-carrier head section is capable of accommodate to one or more tools.

The selected tools may be any tools suitable for treating a surface including but not limited to: nozzles, jets, sprinkles, brushes, air tools, such as air driven flails, air blowers, nozzles for spray painting; rotational brushes, high pressure nozzles, high pressure turbo nozzle, foam nozzles, steam nozzles, girt blasting nozzles, (video) cameras, measurement instruments etc.

Some of the tools, such as nozzels, jets, air blowers, sand blower etc., require a feed tube providing a feed stream such as pressurized water or air, sand etc. Other tools, such as rotational brushes, provides for an engine connected to the tool-carrier head section and an electrical cord providing the power to drive the engine. Other suitable tools include air tools, such as nozzles for spray painting. The feed tube and/or the electrical cord may be connected to the pole in order to restrict movement of the tube around the working area of the device, or it may be provided hanging down from the top of the surface to be treated. The latter is preferred, because it does not give rise to any additional tubes and/or cord in the working area around the device and further, it reduces the weight carried by the pole.

The tool-carrier head section is preferably provided with one or more wheels or rolls easing the movement up and down.

### Winch, Line and Overhead Support

In some preferred embodiments the device is further provided with a winch and a line connected in one end to the winch and in the other end to the tool-carrier head section and/or to the pole as a location distant to the base unit. The line is further connected to an overhead support, where the connection allows free movement of the line and the overhead support carries the weight borne by the line.

The winch is preferably attached to the base unit and controlled by the operator, so the winch and line arrangement carries a significant part of the weight of the pole and tool-carrier head section.

The overhead support is a grip located above the surface to be treated, e.g. at the top of the surface, which grip can carry the line and the weight carried by the line and, at still, allow the line to glide through the grip by the action of the winch.

The overhead support may be provided by an eye through which the line can pass or a pulley.

If the device is intended for use in a bulk cargo room in a vessel, the overhead section may even be provided by a wire strapped across the open top hatch of the cargo room.

### Use of the Device

In use the device of the invention is placed in front of the substantially vertical surface to be treated, so the tool-carrier head section contacts the surface and the operator is located at the base unit. The base unit is moved towards the surface and the winch, if provided, is engaged in order to raise the tool-carrier head section up the surface. When the tool-carrier head section reaches its maximal height on the surface it may be lowered again, and the device drawn back from the surface and relocated to the next section that needs treatment and the process repeated.

The tools of the tool-carrier head section may be engaged and treat the surface to be treated, when the tool-carrier head section is raised, when it is lowered or both, depending on the particular treatment. It may even be possible to use one tool when the tool-carrier head section is raised and a second tool when the tool-carrier head section is lowered again.

For example, for a cleaning treatment, a nozzle spraying cleaning chemicals may be active when the tool-carrier head section is raised and a nozzle spraying rinsing water is active when the tool-carrier head section is lowered again. In this way a two-step treatment can be completed in a single operation.

### Preferred Embodiment, Use in a Bulk Carrier

In a preferred embodiment the device of the invention is intended for use for cleaning substantial vertical sides and overhangs of cargo rooms of a bulk carrier.

In this embodiment it is preferred to use a device of the invention comprising a winch with a line supported by an overhead support, e.g., established by strapping a wire across the open top hatch of the cargo room. Further, it is preferred to supply feeding tubes for tools attached to the tool-carrier head section, e.g. a tube feeding pressurized water for nozzles treating the surface with high pressure spraying; and electrical cords providing power to the device, from the deck of the ships, so the feeding tubes and electrical cords are hanging from above via the top hatch of the cargo room to the respective connections on the device. In this way the pole is relieved of the weight of the tubes and cords, and further this arrangement avoids any hazards around the working space for the device caused by tubes and/or cords lying on the working area. If the cargo room comprises corrugated bulk head surfaces it is further preferred to use a tool-carrier head section connected to the pole with a hinge that allows movement in all directions or by providing the tool-carrier head section with tools that can engage sideways in order to treat the corrugated bulk head surfaces.

Such a device can conveniently be operated by two persons, one person located at the base unit, operating the device, and one person located on the deck controlling the feed streams provided in the feeding tubes, and optionally moving the line along the overhead support, if necessary, when the surface treating operation progresses from one part of the surface to be treated to an adjacent part of the surface. It may even be possible to perform the process by only one person provided that the feed stream is remotely operable, and the overhead support may be provided with a small engine allowing the operator to control all elements from the base unit.

However, on many bulk carrier ships it is practice to always maintain a person on deck when work is performed in cargo rooms, and the person on deck need not to be fully dedicated to the cleaning operation using the device, but can support the operator in the cargo room when needed, between other tasks on the deck.

Traditionally, cleaning of walls of cargo ships is performed using a number of manually carried devices, optionally supported on tripods etc. ; such as high-pressure cleaners. Due to the short range of such equipment, it is often necessary to used ladders, scaffolds or gallows hanging along the wall, which may provide for ergonomically not ideal positions of the crew, which may lead to injuries due to bad working positions and may further lead to an uneven cleaning of the surface. So traditionally, cleaning walls of cargo ships has been a labor intensive operation, typically perform by teams of 4 or more persons, and because of the high reliance of manually operations, the cleaning may become inhomogeneous because different persons may operate the equipment slightly different giving different cleaning efficiency, and further has provided many injuries to the persons performing the cleaning, due to extensive use of heavy equipment and awkward position on ladder, scaffolds etc.

So, in comparison with traditional cleaning operations the device of the present invention provides the benefits of:
Operable by one (or two, depending on the setting) operators for cleaning a cargo room;
Low (continuous) load is required by the operator, typically a force between 5-10 kg is required, with a little higher peak loads e.g. up to 15-20 kg, which is fully compatible with most work environment recommendations, where many countries has work environmental rules requiring that force delivered by employees should be less than 20 kg;
Good ergonomic positioning of the operator, hazardous positions are avoided since the operator is located on the floor/bottom;
Uniform performance can be obtained since the angle of the tool to the surface and the speed of movement is controlled by the device and can easily be applied at the complete surface, and is repeatable;
Only one operation may be necessary for performing a cleaning operation e.g. using a high pressure cleaning tool, optionally combined with application of cleaning chemicals;
The operator is separated from the cleaning site (by the length of the pole) meaning the operator is less exposed to water mist, dirt and cleaning or other chemicals;
Feeding tubes and electrical cords hanging down from the deck provide no hazards that the operators or others can fall in during operation.

Even though the device has mainly been described in connection with treating surfaces onboard cargo ships, the skilled person will appreciate that the device can be used for treating any substantial vertical surface of a certain height, independent of whether the surface is placed on ships or on land-based facilities.

### EXAMPLES

### Example 1. Tool-Carrier Head Section

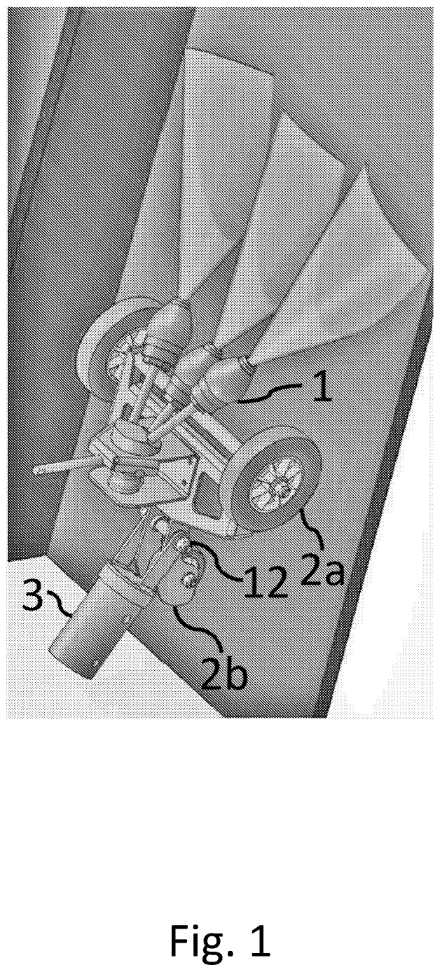

A tool-carrier head section as shown in FIG. 1 was made in aluminum, and provided with 3 rubber wheels, two in front on each side of the nozzles and one behind under the hinge. The tool-carrier was equipped with 3 high pressure Turbo nozzles, (max pressure 180 bar and max temperature 90°C, orifice 0.84 mm in diameter, spread 40°) and provided with a ½″ inlet for the feed tube providing high pressure water.

The tool-carrier head section was, via a hinge, provided via a connection fitting into the aluminum pole, with an outer diameter of 80 mm and inner diameter of 74 mm, disclosed in example 3.

### Example 2. Tool-Carrier Head Section

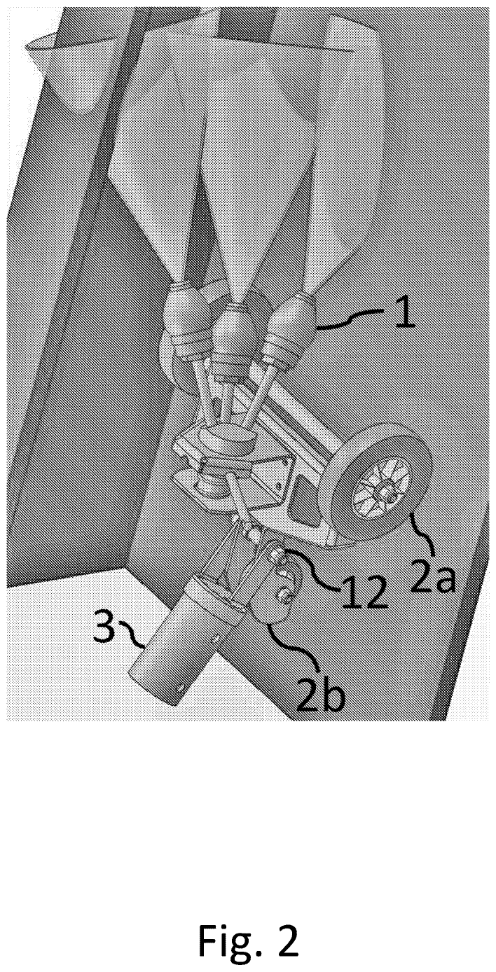

A second tool-carrier head section was made essentially as described in Example 1, except that the nozzles were arranged so they were capable of treating a surface perpendicular to the surface on which the tool-carrier head section was running. This tool-carrier head section is shown in FIG. 2.

### Example 3. Pole Elements

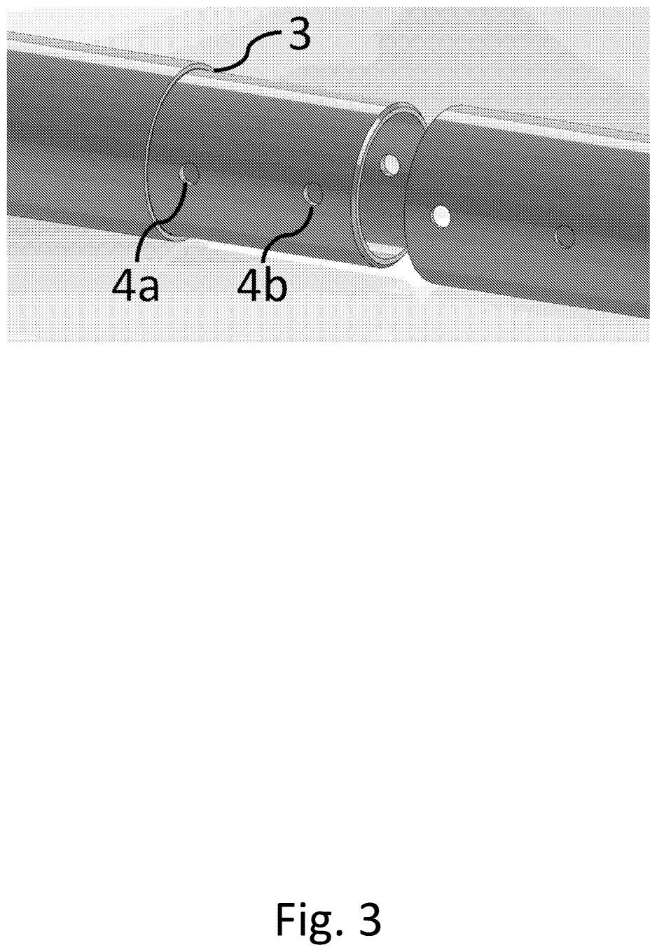

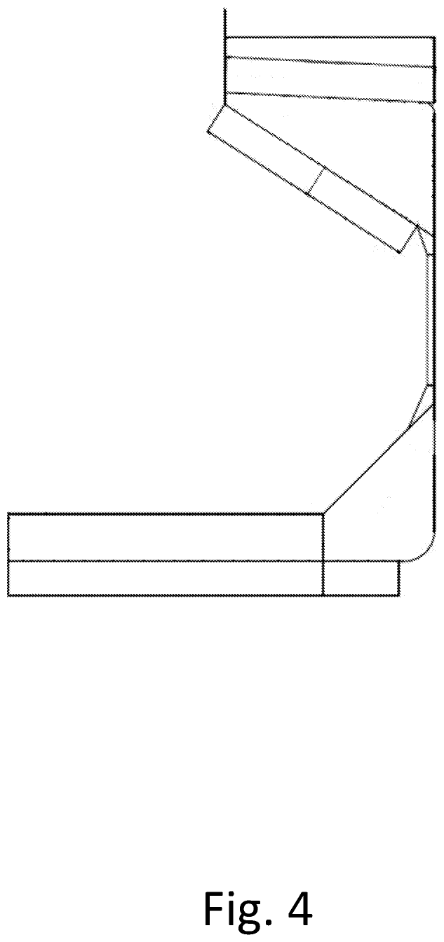

A pole was made by connecting a number of pole elements each of a length of 2 m. The pole elements were made of aluminum tubes with an external diameter of 80 mm and an inner diameter of 74 mm and were in one end provided with a short tube section of a smaller diameter fitting into the next element, and the ends were further provided with holes for inserting pins for securing the pole in locked position. The ends for connecting are shown in FIG. 3.

### Example 4. Base Unit

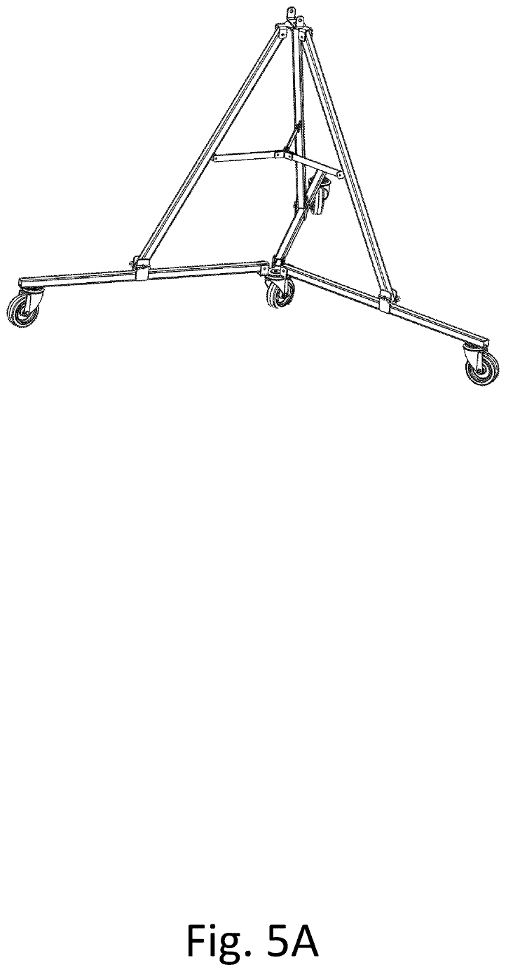

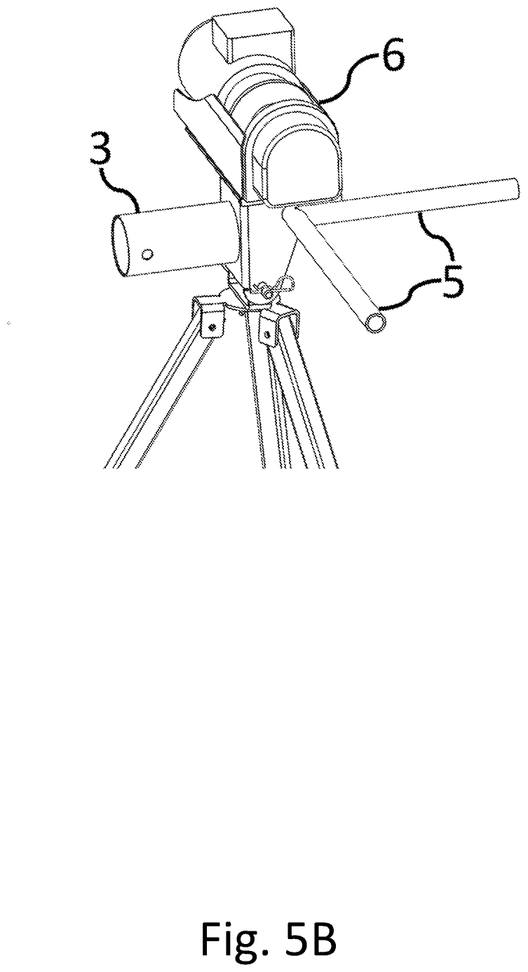

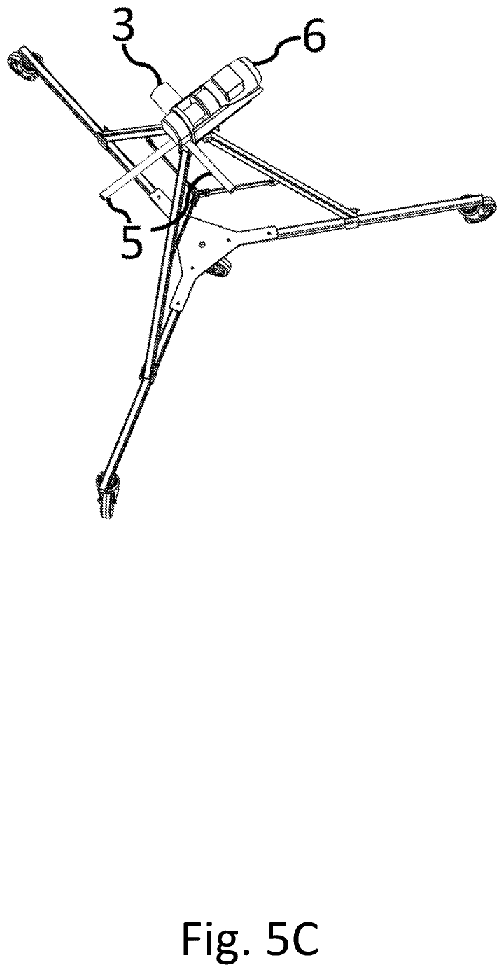

A base unit was made based on a tripod (see FIG. 5A), on which handles for operating and a winch were attached, see details on FIG. 5B and view from the top in FIG. 5C.

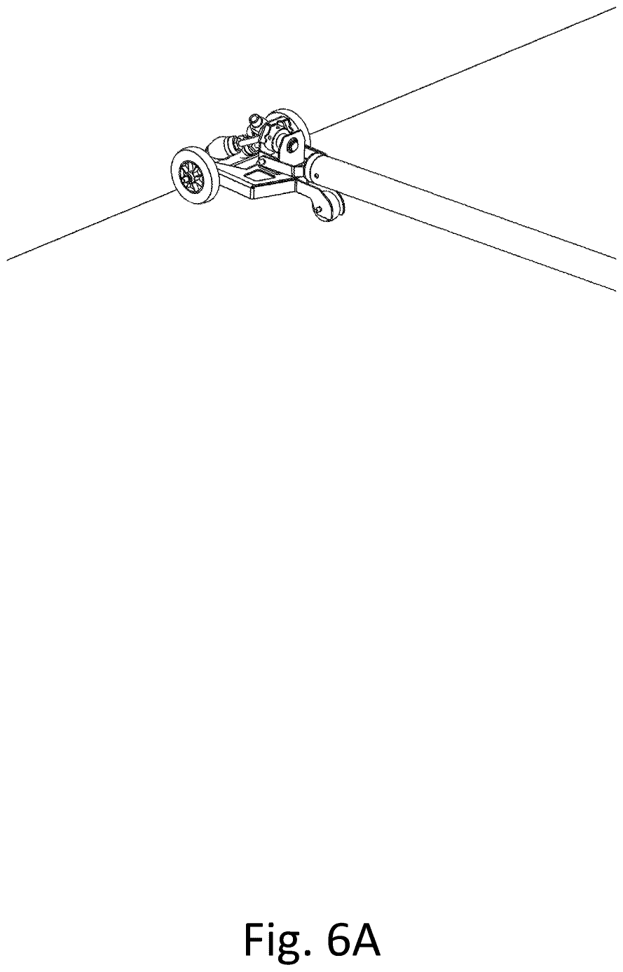

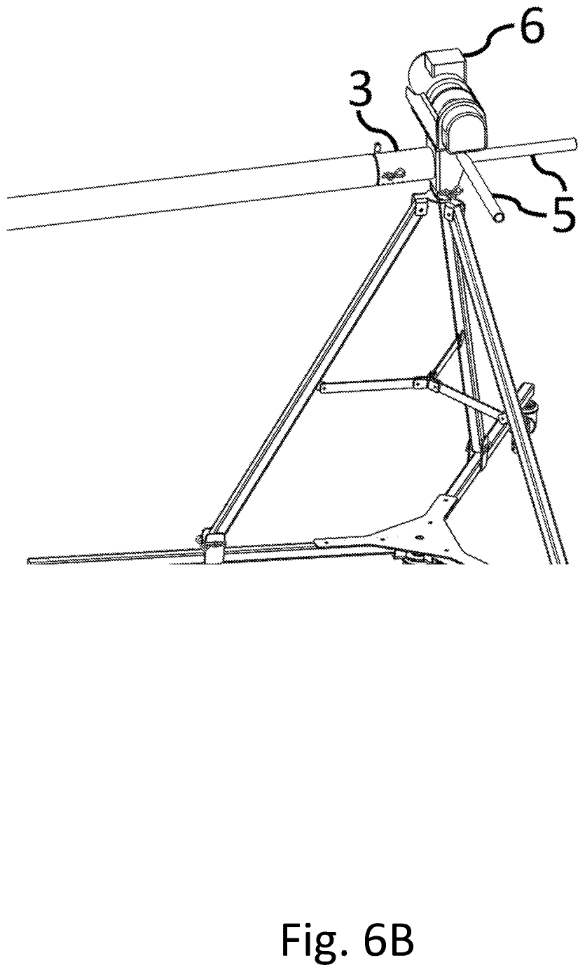

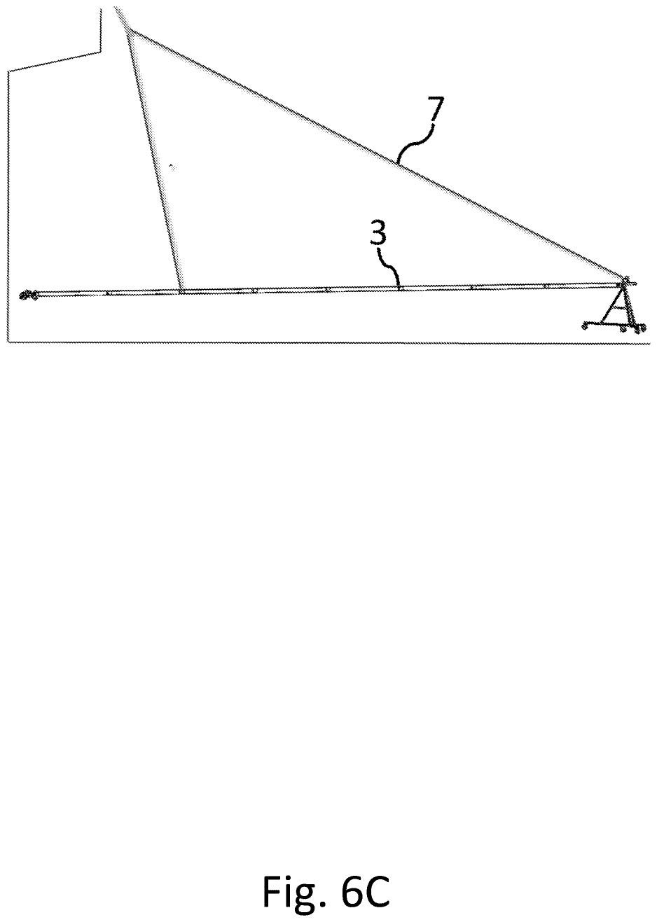

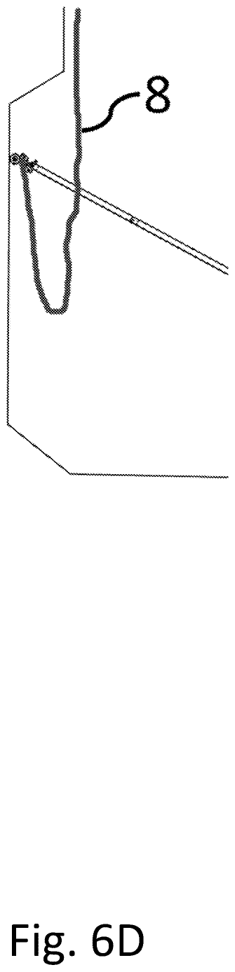

The tool-carrier head section disclosed in example 1, was placed up to the surface to be treated and connected to a pole as disclosed in Example 3, (see FIG. 6A). The other end of the pole was attached to the base unit as shown in FIG. 6B, and attached to the winch led via an overhead support and attached to the pole. See FIG. 6C.

The feeding tube providing high pressure water was hanging down from the deck and attached to the nozzles attached to the tool-carrier head section. See FIG. 6D.

### Example 5. Base Unit

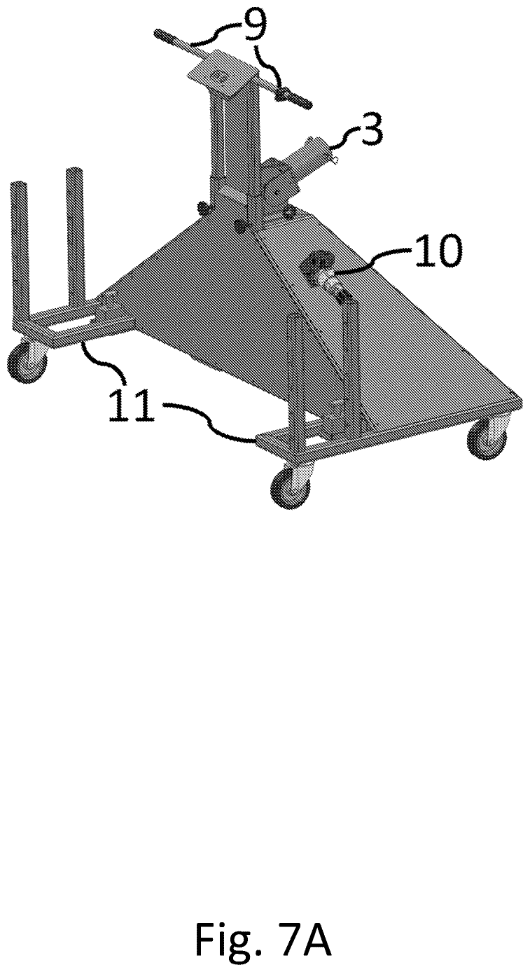

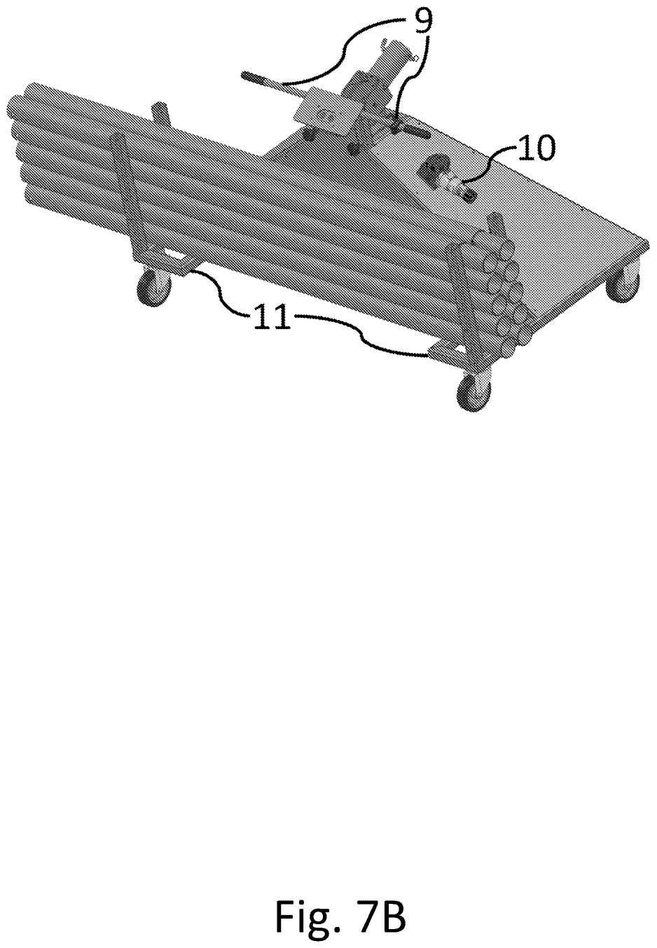

A base unit was made with a rectangular basis with rubber wheel in each corner, provided with a handle with a control panel, a pivotal hinge connected with a piece of a tube adapted to receive one end of a pole and a winch, see FIG. 7A.

The base unit further comprises a place for storing pole elements as described in Example 3, when not in use, see FIG. 7B.

### Example 6. Cleaning Device

A cleaning device consisting of the base unit of example 5, pole elements as described in example 3 forming a pole and a tool-carrier head section as described in example 1.

The device was placed in a cargo room of a bulk carrier vessel, with the tool-carrier head section placed adjacent to the wall to be treated, and the line connected to the winch was led via an overhead support and attached to the pole using a two-point attachment, with one attachment to the tool-carrier head section and a second attachment approximately 2 m down the pole.

The treatment was started, and the performance of the device recorded.

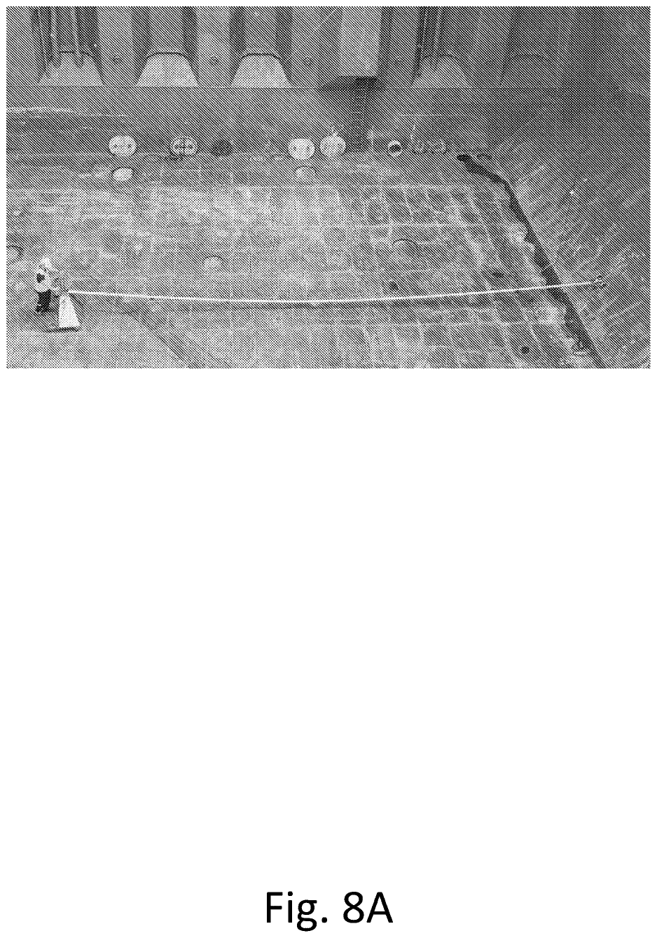

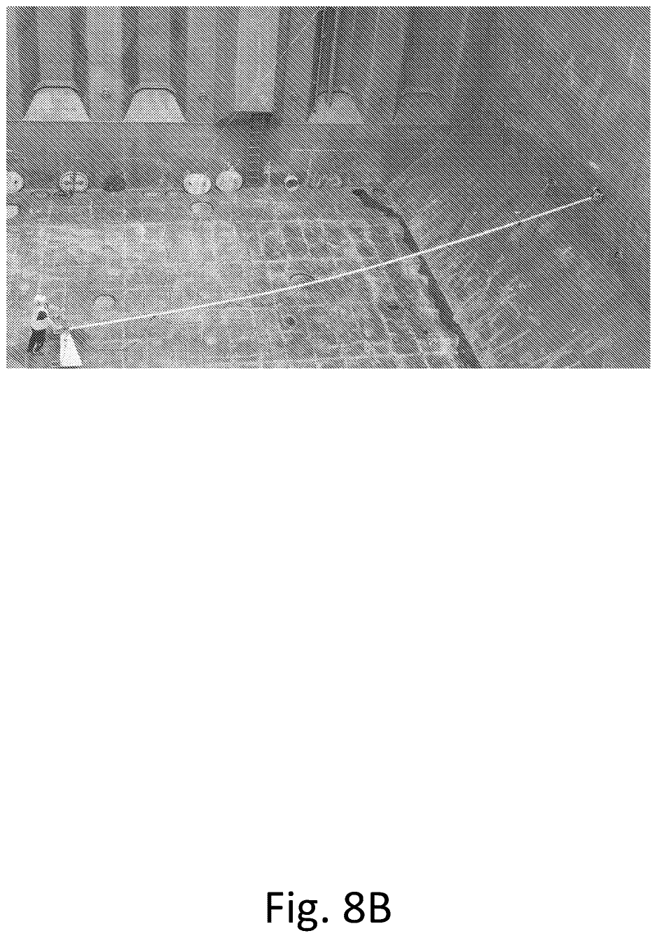

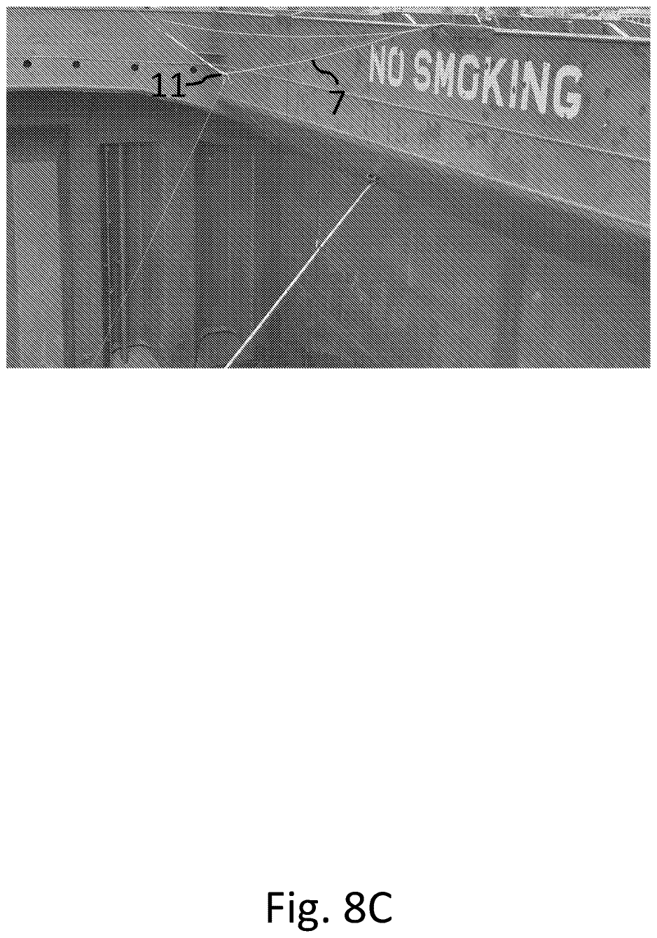

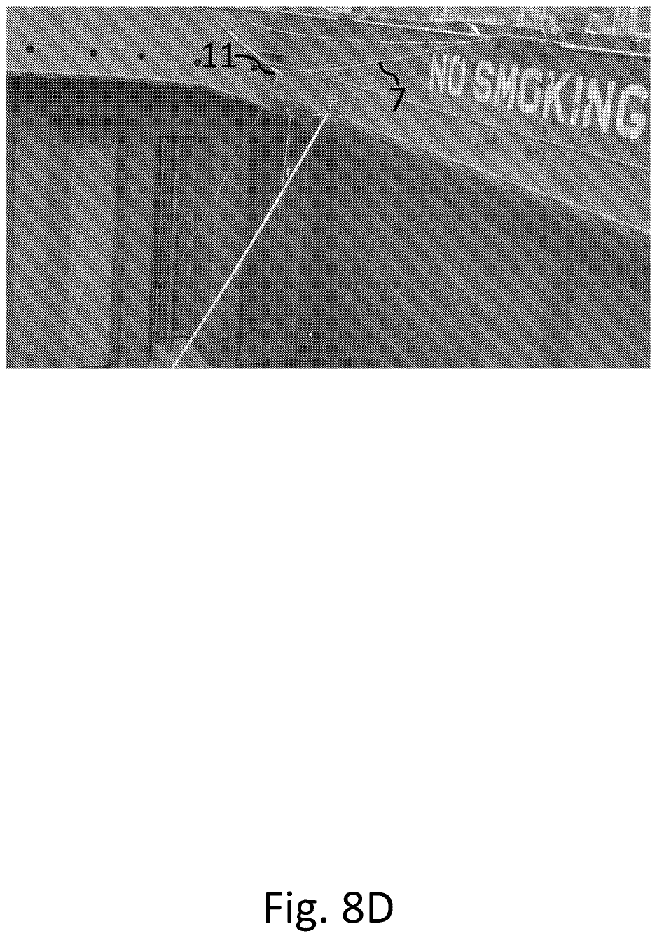

FIG. 8A shows a picture of the test immediately after start when the pole was practically horizontal and the tool-carrier head section at the lower part of the surface.

FIG. 8B shows a picture of the test after the tool-carrier head section had moved some distance up the surface.

FIG. 8C shows a picture of the test, where the tool-carrier head section had reached a part of the surface to be treated with an overhang. The device of the invention was capable of moving and treating the surface also on the overhang part of the surface.

FIG. 8D shows a picture of the test when the tool-carrier head section had reached the top of the surface to be treated, above the overhang.

FIGS. 8C and 8D further show the line connected with the overhead support in form of a wire spanning across the top hatch of the cargo room.

### Example 7. Load of the Operator

The experiment described in example 6 was repeated and the force the operator had to deliver to perform the cleaning operation was measured, using a balance for measuring the force required to move the device forth and back, indicated in kg.

The results showed that the force the operator had to deliver corresponded to a load of 6-10 kg with peak loads of up to 12 kg.

### Example 8. Analyzing the Balance of the Device

The base unit disclosed in Example 4, was provided with a pole as described in Example 3, and a tool-carrier head section of Example 1, and a line was provided between the winch and the pole via an overhead support. The device was tested in a cargo room of a vessel.

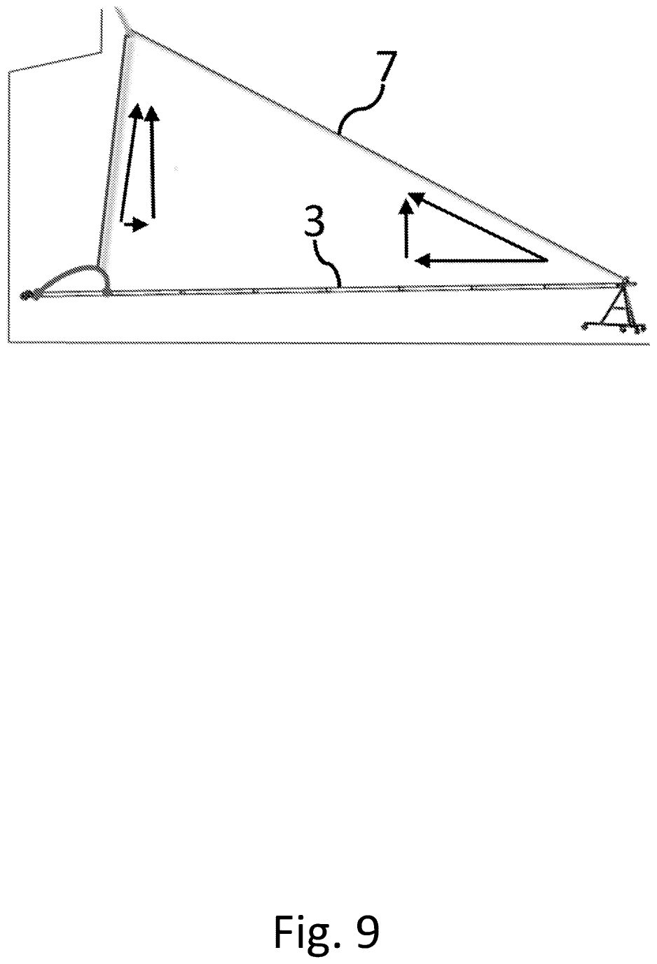

The set-up is schematically shown in FIG. 9 together with force vectors for the load carried by the line. The force vectors along the line on each side of the overhead support are of the same sizes, but when the force-vectors are distributed into horizontal and vertical components, it can clearly be seen on the figure, that the horizontal component closest to the wall of the cargo room is smaller than the horizontal component shown distant to the wall of the cargo room, with the net effect that the pole and the tool-carrier head section efficiently is pressed toward the wall because of gravity and the arrangement of the line as an overhead support.

The theoretical consideration based on force-vectors explained above was confirmed in the practical test where it was found that the tool-carrier head section was squeezed to the wall during operation.

1. A device for treating substantially vertical surfaces and/or overhanging surfaces, said device comprising a base unit, a pole and a tool-carrier head section; wherein
a. the base unit comprises
i. a structure allowing attachment to the pole,
ii. means allowing said base unit to move on a substantially horizontal surface,
iii. grip(s) for an operator
iv. control elements for the device; and
v. a winch attached to the base unit;
b. the pole is attached in one end to the base section and in the other end to the tool carrier head section; and
c. the tool carrier head section comprises
vi. means allowing the tool carrier head section to move up or down on the vertical or overhanging surfaces, and
vii. means allowing accommodating one or more tools;
wherein the base unit is connected to the pole by a pivotal hinge allowing movement of the pole around the pivotal hinge so the pole can have an adjustable angle with respect to horizontal, wherein the pole in the other end is connected to and supports the tool carrier head section, and wherein a line is attached to the winch in one end of the line and the other end of the line is attached to the distal end of the pole or to the tool carrier via an overhead support.

2. (canceled)

3. (canceled)

4. The device according to claim 1, wherein the substantial vertical surfaces are surfaces having an angle in the range of 0-45° with vertical.

5. The device of claim 1, wherein the substantial vertical surfaces and/or overhanging surfaces are surfaces of a section of a ship designed to transport materials in bulk.

6. The device according to claim 1, wherein the adjustable angle with respect to horizontal is in the range of 0-90°.

7. The device according to claim 1, wherein the pole is connected to the tool carrier head section with a connection allowing the tools of the tool-carrier head section to engage with the surface on which it is located.

8. The device according to claim 1, wherein the pole has a length in the range of 1-40 m, preferably in the range of 1.5-30, more preferred in the range of 2-20 m.

9. The device of claim 6, wherein the pole is modular, composed of two or more sections assembled before use in an intended length engaging with each other.

10. The device according to claim 7, wherein the pole is hollow, and further comprises wires and feed tube to the tool(s) of the tool-head section within the pole.

11. The device according to claim 1, wherein the tool carrier head section is provided with one or more tools selected among: nozzles, jets, sprinkles, brushes, air tools, such as air driven flails, air blowers, nozzles for spray painting;
rotational brushes, high pressure nozzles, high pressure turbo nozzle, foam nozzles, steam nozzles, girt blasting nozzles, (video) cameras, and measurement instruments.

12. The device according to claim 26, wherein the tool carrier section is connected to the pole with a hinge allowing movement in 1, 2 or 3 dimensions.

13. The device according to claim 1, wherein the treatment of the surfaces is a cleaning treatment.

14. The device of claim 11, wherein the tool carrier head section comprises one or more nozzle(s), jet(s) or sprinkler(s) capable of treating the surfaces with a cleaning liquid.

15. The device of claim 12, further comprising brushes.

16. The device according to claim 13, wherein the cleaning liquid is pressurized water.

17. The device according to claim 16, wherein a tube providing the pressurized water is hanging from above with respect to the device.

18. The device according to claim 15, further comprising one or more separate nozzle(s) capable of applying cleaning chemicals to the surface.

19. The device according to claim 1, wherein the treatment of the surfaces is a painting process.

20. The device of claim 19, wherein the tool carrier section carries at least one nozzle for spray painting.

21. (canceled)

22. The device according to claim 1, wherein the overhead support is provided by a line spanning an open hatch.

23. The device according to claim 1, wherein the winch is powered by an electrical motor.

24. A use of a device according to claim 1 for cleaning or painting a substantially vertical surface.

25. The use of claim 24, wherein the substantial vertical surface is part of a cargo room in a cargo ship.

26. The device of claim 7, wherein the sections are tubes and the tubes in one end are provided with a short tube section of a smaller diameter fitting into the next tube, and the ends are provided with holes for inserting pins for securing the pole in locked position.
